(19) United States
(12) Patent Application Publication
(10) Pub. No.: US 2014/0265187 A1
(43) Pub. Date: Sep. 18, 2014

(54) BOX WITH DEPLOYABLE WHEELS

(71) Applicant: Eastpoint Sports Ltd., LLC, Whippany, NJ (US)

(72) Inventors: Michael J. Nally, Whippany, NJ (US); Adam B. Abramson, Oxford, NJ (US); James P. Burns, Cranford, NJ (US)

(73) Assignee: Eastpoint Sports Ltd., LLC, Whippany, NJ (US)

(21) Appl. No.: 14/214,746

(22) Filed: Mar. 15, 2014

Related U.S. Application Data
(60) Provisional application No. 61/800,713, filed on Mar. 15, 2013.

(51) Int. Cl. B62B 3/02

(52) U.S. Cl. CPC B62B 3/02
USPC 280/38

(57) ABSTRACT

A box with deployable wheels. The box includes peripheral walls and side panels defining an enclosed interior compartment for receiving an object. At least one deployable wheel assembly is disposed along the bottom peripheral wall. The deployable wheel assembly includes a wheeled base assembly pivotably moveable through an opening in the bottom peripheral wall from a storage position within the interior compartment to a deployed position exterior of the bottom wall. When the wheeled base assembly is in the deployed position, the box is capable of being rolled on the wheeled base assembly.

### BACKGROUND

Game tables, such as pool tables, billiard tables, air hockey tables, and the like, have table dimensions typically ranging between 3.5 to 5 feet wide and 7.0 to 10.0 feet long and can weigh well over several hundred pounds. When shipped to retail outlets or direct to the purchasers' home or business, the game tables are typically packaged in boxes or crates made of cardboard or wood. It should be appreciated that due to the size and weight of the boxes containing these game tables, they are difficult to move and handle, whether by employees that must move the boxes while in storage at the retail outlets, or by delivery personnel, or by the purchasers when moving the boxes to the room within a home or business where the game table is to be located. Furthermore, due to their size, in order to move the boxes through doorways or hallways of a home or business, the boxes must be oriented with the short sides of the box positioned vertically and the long sides facing up and down. It is difficult to carry the large heavy boxes when orientation in such a position, so the boxes are typically slid or pushed along the floor, which can potentially scratch the floor surface or potentially snag and damage a carpeted floor. Alternatively, in order to move the large, heavy boxes, wheeled carts, dollies or hand trucks can be placed under each end of the box so the box can be rolled to the desired location. While delivery personnel and store employees may have wheeled carts readily available, homeowners typically will not, and therefore homeowners either have to rent wheeled carts or risk damaging their floors by pushing the boxes along the floor.

Accordingly, there is a need for a box in which game tables, furniture items or other large, heavy consumer products or other objects may be packaged, which permits the box to be rolled with relative ease thereby avoiding the need to carry the heavy box or the need for employing separate wheeled carts, dollies or hand carts to move the box.

### BRIEF DESCRIPTION OF THE DRAWINGS

FIG. 1 is a perspective view of one embodiment of a box lying on bottom side panel showing an embodiment of the deployable wheel assemblies in the storage position on a bottom sidewall of the box.

FIG. 2 is an enlarged perspective view of the circled area in FIG. 1

FIG. 3 is a perspective view of the box of FIG. 1 with the deployable wheel assemblies in the deployed position and the box oriented with the bottom sidewall facing down and the endwalls vertical.

FIG. 4 is an enlarged perspective view of a corner of the box of FIG. 1 showing one the deployable wheel assemblies in the storage position.

FIG. 5 is the same view of the box corner of FIG. 4, but showing one of the deployable wheel assemblies in the deployed position.

FIG. 6A is a partial cross sectional view of the box as viewed along line 6-6 of FIG. 2.

FIG. 6B is the same partial cross-sectional view as FIG. 6A, but showing the deployable wheel assembly being moved from the storage position to the deployed position.

FIG. 6C is the same partial cross-sectional view as FIG. 6A, but showing the deployable wheel assembly in the deployed position.

### DESCRIPTION

Referring now to the drawings wherein like reference numerals designate identical or corresponding parts throughout the several views, FIG. 1 illustrates one embodiment of a box 10 within which is packaged an object 12, such as a game table, furniture item or other large, heavy consumer product or other object. The box 10 has a length L, a width W and a depth D. For illustration purposes only, the depth D is shown as being relatively narrow and the length L is shown as being substantially longer than the width W. The box 10 includes peripheral walls including top and bottom sidewalls 14, 16, left and right endwalls 18, 20 and further comprising opposing side panels 22, 24 defining an enclosed compartment in which the object is received. When the box 10 is oriented in the position as shown in FIG. 2 (i.e., with the top and bottom sidewalls 12, 14 facing up and down and left and right endwalls vertical) the box will pass through a conventional household door or hallway or narrow passage or corridor. It should be understood that the box 10 may be made of any suitable material conventionally used for packaging objects, including cardboard, wood or other suitable materials. Furthermore, it should be understood that the box can have any configuration and any length, width and depth dimensions.

Referring again to FIGS. 1 and 2, the box 10 includes deployable wheel assemblies 100. For illustration purposes only, the deployable wheel assemblies 100 are shown positioned on the bottom sidewall 16 proximate the corners of the box such that when the box 10 is oriented as shown in FIG. 2, the deployable wheel assemblies 100 are disposed on the side of the box adjacent to the floor 26 (FIG. 5C), so that when the wheels are deployed (discussed later), the box can be rolled along the floor to the desired location.

It should be appreciated that the number and location of the deployable wheel assemblies 100 on a box 10 may vary depending on a number of factors, including, for example, the dimensions and configuration of the box, the weight distribution of the object within the box, the configuration and position of the object within the box which may dictate where reinforced areas of the box are located capable of supporting the weight of the box on the wheels, and the side of the box which will permit the box to pass through doorways or other narrow passages.

As best illustrated in FIGS. 4 and 5, the deployable wheel assembly 100 in the embodiment illustrated is positioned proximate the corner of the box defined by the intersection of the bottom sidewall 16 and right endwall 20. The bottom sidewall 16 is cut or perforated along two parallel spaced lines 30, 32 and along a third perpendicular or intersecting line 34 thereby defining an access door 36 and an opening 38 for gaining access to the deployable wheel assembly 100 disposed within the interior of the box. When the access door 36 is opened (FIG. 4), the uncut side between the spaced parallel cuts 30, 32 acts as a hinge and the deployable wheel assembly 100 is exposed in its storage position. To assist the user to tear the perforations or otherwise open the access door, a finger hole 40 may be provided along on one or more of the cut or perforated edges of the access door so the user can insert his/her finger to grasp and pull the access door 38 open.

Referring to FIG. 5 and FIGS. 6A-6C, the deployable wheel assembly 100 includes a wheeled base assembly 102 secured by a hinge 104 to a reinforcing member 106 secured to the inside surface of the sidewall 16 by staples, adhesive or other suitable attachment means. The hinge 104 may be any type of hinge mechanism, such as a piano-hinge, butterfly hinges or a flexible material secured to opposing ends of the wheeled base assembly 102 and the reinforcing member 106. The wheeled base assembly 102 includes a block 108 and a pair of wheels 110, 112 rotatably supported on an axle 114 secured to the block 108. In the embodiment illustrated, the axle 114 is received within a U-shaped plate 116 secured to the block 108 by threaded connectors 118 (FIG. 5), however, any suitable means for rotatably securing wheels to the block 108 may be utilized as would be recognized by those of skill in the art. It should also be appreciated that instead of a pair of wheels rotatably supported by an axle, caster wheels (either fixed or rotatable) may be secured to the block 108. The block 108 and reinforcing member 106 may be made of any suitable material, such as pressboard, chipboard, plywood, plastic or other suitably rigid material. Because the box 10 is typically discarded and not reused after the object is removed from the box, the material is preferably inexpensive so as not to add significantly to the cost.

FIGS. 6A-6C show the steps for dispensing the deployable wheel assembly 100. In FIG. 6A, the access door 36 is shown in the closed position with the deployable wheel assembly 100 hidden and protected behind the access door 36. In FIG. 6B, the access door is shown as being opened downwardly (or it could be opened upwardly depending on the orientation of the cuts 30, 32, 34) exposing the deployable wheel assembly 100 in the storage position within the interior of the box 10. Also in FIG. 6B, the wheeled base assembly 102 is shown as being pivoted outwardly as indicated by arrow 120, with the hinge 104 serving as the pivot axis. The back side of the wheeled base assembly 102 may include a double sided adhesive 122 with a removable backing tape 124 protecting the adhesive. To expose the adhesive, the backing tape 124 is peeled away from the adhesive 122 as indicated by arrow 126 in FIG. 6B. In FIG. 6C, the wheeled base assembly 102 is shown as being fully pivoted outwardly until the exposed adhesive is adjacent the outside surface of the bottom sidewall 16. The wheeled base assembly 102 is then firmly pressed against the outside surface of the bottom sidewall 16 to adhere it in place. With the wheeled base assembly 102 adhered to the outside surface of the bottom sidewall 16, the access door 36 may be closed by pushing it back into the opening 38 as illustrated in FIG. 5 so it does not catch on the floor surface and interfere with the ability of the box to be rolled along the floor surface. The process is repeated at the other end of the box to deploy the other wheeled base assembly 100. With both wheels deployed and the access doors 36 closed back into their respective openings 38, the box 10 can be lifted from the position shown in FIG. 1 to the position shown in FIG. 2 with the wheels deployed below the box permitting the box 10 to be rolled along the floor surface to the desired location. It should be appreciated that adhering the back side of the wheeled base assembly 102 to the outside surface of the sidewall 16 prevents the wheeled base assembly from pivoting outwardly while the box is being lifted into the position shown in FIG. 2.

Spacers 130 may be spaced around the periphery of the object 12 and the interior surface of the sidewalls 14, 16 and endwalls 18, 20 to securely restrain the object 12 within the box 10 so it does not move within the box during shipment. As best illustrated in FIG. 6A, the spacers 130 at the bottom sidewall 16 also serve to create a cavity for receiving the deployable wheel assemblies 100 when in the storage position. Furthermore, referring again to FIG. 6C, it should be appreciated that the reinforcing member 106 serves to reinforce the bottom sidewall 16 of the box at the point where the weight of the box is supported by the wheels. Additionally, it should be appreciated that it is desirable to position one of the spacers 130 between the interior block 106 and the packaged object 12, such that when the box is oriented into the position shown in FIG. 2, the spacer 130 serves to transfer the weight of the object 12 to the reinforcing member 106 producing a reactionary downward force R (FIG. 6C) to counteract the upward force F exerted by the wheels on the bottom sidewall 16, thereby preventing the bottom sidewall 16 from collapsing.

The backside of the access door 36 may include printed instructions for showing users how to properly deploy the wheels. Alternatively, instructions may be printed on the removable backing tape 124 covering the adhesive 122 on the wheel base assembly 102 or printed instructions may may be inserted on a separate card which is accessible upon opening the access door 36.

Based on the foregoing, it should be appreciated that the embodiments of the box 10 with deployable wheel assemblies 100 enables large heavy boxes containing game tables, furniture items or other large heavy objects consumer products or other object to be shipped without the wheels deployed, thereby taking up less space during shipment and avoiding the wheels being damaged during shipment. However, when the box reaches its destination at a retail outlet, or when the box is being delivered to a purchaser by delivery personnel, or after the box is delivered to the purchaser, the wheels may be easily deployed to permit the box to be moved with relative ease without the need to employ two or more separate wheeled carts, dollies or hand carts which may not be readily available. Furthermore, by positioning the deployable wheels on a side of the box that is narrower than a typically doorway of a home or business, the box can be rolled through doors and along hallways, corridors or other narrow passages by the purchaser after delivery of the box.

The foregoing description is presented to enable one of ordinary skill in the art to make and use the invention and is provided in the context of a patent application and its requirements. Various modifications to the embodiments described and illustrated in the drawing figures will be readily apparent to those of skill in the art. Thus, the present invention is not to be limited to the embodiments described and illustrated in the drawing figures, but instead should be accorded the widest scope consistent with the spirit and scope of the appended claims.

1. A box with deployable wheels, comprising:
peripheral walls and side panels defining an enclosed interior compartment for receiving an object, one of the peripheral walls being a bottom wall, the bottom wall having at least one opening through which the interior compartment is accessible;
at least one deployable wheel assembly disposed along the bottom wall, the deployable wheel assembly comprising:
a wheeled base assembly pivotably moveable through the at least one opening from a storage position within the interior compartment to a deployed position exterior of the bottom wall;
whereby when the wheeled base assembly is in the deployed position, the box is capable of being rolled on the wheeled base assembly.

2. The box of claim 1, further comprising an access door hingedly movable between a closed position covering the opening and an open position exposing the wheeled base assembly when in the storage position within the interior compartment.

3. The box of claim 2, wherein the wheeled base assembly includes a block supporting a pair of wheels on a first side of the block, whereby when in the storage position, the wheels project into the interior compartment and when in the deployed position, the wheels project away from an exterior surface of the bottom wall.

4. The box of claim 3, wherein the deployable wheel assembly further comprises a reinforcing member secured to the bottom wall within the interior compartment, the wheeled base assembly hingedly secured to the reinforcing member.

5. The box of claim 3, wherein a second side of the block includes an adhesive surface, whereby when the wheeled base assembly is in the deployed position the adhesive surface bonds the second side of the block to the exterior surface of the bottom wall.

6. The box of claim 1, wherein the peripheral walls and sidewalls are cardboard.
